(19) United States
(12) Patent Application Publication
(10) Pub. No.: US 2022/0320492 A1
(43) Pub. Date: Oct. 6, 2022

(54) CATHODE FOR ALL-SOLID-STATE LITHIUM-SULFUR BATTERY

(71) Applicant: TOYOTA JIDOSHA KABUSHIKI KAISHA, Toyota-shi Aichi-ken (JP)

(72) Inventor: Masatsugu Kawakami, Suntou-gun Shizuoka-ken (JP)

(21) Appl. No.: 17/695,208

(22) Filed: Mar. 15, 2022

(30) Foreign Application Priority Data
Apr. 2, 2021 (JP) 2021-063627

(51) Int. Cl. H01M 4/36; H01M 4/04; H01M 4/58

(52) U.S. Cl. CPC H01M 4/364; H01M 4/043; H01M 4/5815; H01M 2004/027

(57) ABSTRACT

Provided is a cathode for an all-solid-state lithium-sulfur battery that makes the discharge capacity improved. The cathode for an all-solid-state lithium-sulfur battery includes: a cathode mixture containing sulfur, a carbon nanotube, P₂S₅, and an Li₂S—P₂S₅ based solid electrolyte, wherein the sulfur, the carbon nanotube, and the P₂S₅ form a composite, and the cathode mixture contains higher than 0 wt % and lower than 20 wt % of the carbon nanotube.

### CROSS REFERENCE TO RELATED APPLICATION

This application claims priority to Japanese Patent Application No. 2021-063627 filed on Apr. 2, 2021, the entire contents of which are incorporated by reference herein.

### FIELD

The present application relates to a cathode for an all-solid-state lithium-sulfur battery.

### BACKGROUND

Patent Literature 1 discloses a cathode for an all-solid lithium secondary battery. A feature of this cathode is to be formed of a molded body of a composite that is made by mechanical milling on a raw material mixture that contains: sulfur; a carbon material with a mean particle size at most 100 nm; and an electrolyte expressed by Li₂S-MₓS_{y} (where M is selected from P, Si, Ge, B and Al, and x and y are integers giving stoichiometry in accordance with M).

Patent Literature 2 discloses a positive electrode for an all-solid lithium sulfur battery which comprises a positive electrode mixture including: sulfur; a conductive material; an Li₂S—P₂S₅ based solid electrolyte; and Li₃PO₄. The positive electrode mixture contains 1 mass % to 15 mass % of Li₃PO₄.

### CITATION LIST

### Patent Literature

Patent Literature 1: JP 2011-181260 A

Patent Literature 2: JP 2018-60680 A

### SUMMARY

### Technical Problem

A cathode for an all-solid-state lithium-sulfur battery as described in Patent Literatures 1 and 2 contains sulfur. Thus, in discharging, sulfur (S) is transformed into lithium sulfide (Li₂S) and the volume increases. In charging, lithium sulfide is transformed into sulfur and the volume decreases. As described above, the volume of the cathode for an all-solid-state lithium-sulfur battery increases and decreases in charging and discharging. This may cause an electron conduction path and an ion conduction path to be cut, the electronic conductivity and the ionic conductivity of the cathode to lower, and then the resistance to increase. The increase in the resistance may lead to the decrease in the discharge capacity of the battery.

In view of the above circumstances, an object of the present application is to provide a cathode for an all-solid-state lithium-sulfur battery that makes the discharge capacity improved.

### Solution to Problem

As one aspect to solve the above problem, the present disclosure is provided with a cathode for an all-solid-state lithium-sulfur battery, the cathode comprising: a cathode mixture containing sulfur, a carbon nanotube, P₂S₅, and an Li₂S—P₂S₅ based solid electrolyte, wherein the sulfur, the carbon nanotube, and the P₂S₅ form a composite, and the cathode mixture contains higher than 0 wt % and lower than 20 wt % of the carbon nanotube.

### Advantageous Effects

A cathode for an all-solid-state lithium-sulfur battery according to the present disclosure contains, as described above, a composite (S-CNT-P₂S₅ composite) formed of sulfur, a carbon nanotube (CNT), and P₂S₅. In the S-CNT-P₂S₅ composite, the sulfur and the CNT form a composite. Thus, the S-CNT-P₂S₅ composite makes it possible to suppress cutting of an electron conduction path due to expansion and shrinkage of sulfur in charging and discharging. The S-CNT-P₂S₅ composite further contains P₂S₅. The P₂S₅ makes it possible to secure an ion conduction path in the vicinity of the active material when in contact with Li₂S, which is a discharge product of sulfur. Further, the Li₂S—P₂S₅ based solid electrolyte contained in the cathode makes it possible to secure a long ion conduction path. As described above, the cathode for an all-solid-state lithium-sulfur battery according to the present disclosure makes it possible to suppress cutting of an electron conduction path and an ion conduction path due to expansion and shrinkage of the cathode in charging and discharging, to improve the discharge capacity.

### DETAILED DESCRIPTION

[Cathode for all-Solid-State Lithium-Sulfur Battery]

A feature of a cathode for an all-solid-state lithium-sulfur battery according to the present disclosure is to comprise a cathode mixture containing sulfur, a carbon nanotube, P₂S₅, and an Li₂S—P₂S₅ based solid electrolyte, wherein the sulfur, the carbon nanotube, and the P₂S₅ form a composite, and the cathode mixture contains higher than 0 wt % and lower than 20 wt % of the carbon nanotube.

The “all-solid-state lithium-sulfur battery” is an all-solid-state battery containing sulfur as a cathode active material, and a solid electrolyte having lithium ion conductivity as an electrolyte.

In the cathode according to the present disclosure, sulfur (S) functions as a cathode active material. Sulfur in the present application means elemental sulfur. The shape and size of the sulfur are not particularly limited, but may be the same as conventional ones. For example, particulate sulfur may be used. The content of sulfur in the cathode mixture is not particularly limited, but for example, the cathode mixture may contain sulfur in the range of 1 wt % to 99 wt %.

In the cathode according to the present disclosure, a carbon nanotube (CNT) functions as a conductive aid. The CNT improves the conductivity of the cathode mixture. The CNT is not particularly limited, but may be a single-walled CNT (SWCNT). The fiber length of the CNT may be 2 μm to 10 μm, and may be 2 to 5 μm. The diameter of the CNT may be 1 nm to 100 nm, may be 1 nm 10 nm, and may be 1 nm to 2 nm. The “fiber length” is a length of a long side of a rectangle circumscribed about the CNT, and the “diameter” is a length of a short side of the rectangle circumscribed about the CNT. The cathode mixture contains larger than 0 wt % and lower than 20 wt % of the CNT in embodiments, contains at least 12 wt % and at most 20 wt % of the CNT in embodiments, and contains at least 14 wt % and at most 18.2 wt % of the CNT in embodiments.

In the cathode according to the present disclosure, P₂S₅ functions as a solid electrolyte. The content of P₂S₅ in the cathode mixture is not particularly limited, but for example, the cathode mixture may contain P₂S₅ in the range of 1 wt % to 50 wt %.

In the cathode according to the present disclosure, an Li₂S—P₂S₅ based solid electrolyte improves the lithium ion conductivity of the cathode mixture. The Li₂S—P₂S₅ based solid electrolyte is a solid electrolyte containing Li₂S—P₂S₅. In addition to Li₂S—P₂S₅, any other constituent may be introduced into the Li₂S—P₂S₅ based solid electrolyte. Example of the other constituents include lithium halides such as LiI, lithium hydrides such as LiBH₄, and Li₃PO₄. The Li₂S—P₂S₅ based solid electrolyte, in embodiments, contains at least 90 wt %, and, in embodiments, contains at least 99 wt % of Li₂S—P₂S₅, and may be a solid electrolyte comprising Li₂S—P₂S₅ only. The Li₂S—P₂S₅ based solid electrolyte may be crystalline, and may be amorphous. In the Li₂S—P₂S₅ based solid electrolyte, the compounding ratio of Li₂S and P₂S₅ is not particularly limited, but for example, may be such that Li₂S:P₂S₅=50:50 to 90:10 in molar ratio. The shape and size of the Li₂S—P₂S₅ based solid electrolyte are not particularly limited, but may be the same as conventional ones. For example, a particulate Li₂S—P₂S₅ based solid electrolyte may be used. The content of the Li₂S—P₂S₅ based solid electrolyte in the cathode mixture is not particularly limited, but for example, the cathode mixture contains the Li₂S—P₂S₅ based solid electrolyte in the range of 1 wt % to 50 wt %.

In the cathode according to the present disclosure, the sulfur (S), the carbon nanotube (CNT), and the P₂S₅ form a composite (S-CNT-P₂S₅ composite). Such an S-CNT-P₂S₅ composite may be prepared as follows.

First, an S-CNT composite is made by heat treatment on mixing part of the S and the CNT. Here, the heat treatment may be performed in the atmosphere. The heat treatment temperature is at least the fusion temperature of S and at most 300° C. The reason why an S-CNT composite is obtained through heat treatment is to obtain an S-CNT composite where the S is sufficiently mixed with the CNT without the fiber length of the CNT shortened, from the fused S mixed with the CNT.

Next, the S-CNT composite and P₂S₅ are subjected to mechanical milling, whereby the S-CNT-P₂S₅ composite is obtained. Here, for example, planetary ball milling may be employed for the mechanical milling. The conditions for the planetary ball milling may be the same as the mixing conditions for a conventional cathode mixture. For example, the ratio of the material powder and Zr balls may be 1:30 to 1:50 (wt). The rotation speed may be 300 to 500 rpm, and the time may be 3 to 12 hours.

Whether the S, the CNT and the P₂S₅ form the composite or not may be determined by observation of a cross section with SEM. For example, the S-CNT-P₂S₅ composite and the Li₂S—P₂S₅ based solid electrolyte are different in a phase to be observed. Further, the presence of P and S in the composite containing the S and the CNT shows that the S-CNT-P₂S₅ composite is formed.

The cathode according to the present disclosure contains the S-CNT-P₂S₅ composite and the Li₂S—P₂S₅ based solid electrolyte, thereby bringing about the following effects. First, the S-CNT-P₂S₅ composite makes it possible to suppress cutting of an electron conduction path due to expansion and shrinkage of sulfur in charging and discharging since containing the S-CNT composite. The S-CNT-P₂S₅ composite further contains P₂S₅. The P₂S₅ makes it possible to secure an ion conduction path in the vicinity of the active material when in contact with Li₂S, which is a discharge product of sulfur. Further, the Li₂S—P₂S₅ based solid electrolyte contained in the cathode makes it possible to secure a long ion conduction path. As described above, the cathode according to the present disclosure makes it possible to suppress cutting of an electron conduction path and an ion conduction path due to expansion and shrinkage of the cathode in charging and discharging, to improve the discharge capacity.

The use of an SWCNT as the CNT in the cathode according to the present disclosure makes it possible to further suppress cutting of an ion conduction path because the diameter of an SWCNT is small, and thus an SWCNT has wide dispersibility in the S-CNT-P₂S₅ composite, which also leads to wide dispersibility of the S-CNT-P₂S₅ composite in the Li₂S—P₂S₅ based solid electrolyte.

The cathode mixture in the cathode according to the present disclosure may contain a cathode active material other than sulfur, in addition to the sulfur, as long as the foregoing effects are not marred. The cathode mixture may also contain a solid electrolyte other than the Li₂S—P₂S₅ based solid electrolyte, in addition to the Li₂S—P₂S₅ based solid electrolyte, as long as the foregoing effects are not marred. The cathode mixture may also contain any optional constituent such as a binder as long as the foregoing effects are not marred. Further, the cathode according to the present disclosure may be optionally provided with a cathode current collector of metal foil, metal mesh, or the like, in addition to the cathode mixture.

The cathode according to the present disclosure is made by mixing a cathode material containing the S-CNT-P₂S₅ composite and the Li₂S—P₂S₅ based solid electrolyte with a suitable solvent (for example, an organic solvent such as butyl butyrate) to form a slurry, and applying and drying the slurry onto the cathode current collector or a substrate. For example, one may also mix a cathode material containing the S-CNT-P₂S₅ composite and the Li₂S—P₂S₅ based solid electrolyte, and press-molding the resultant cathode mixture, to prepare the cathode according to the present disclosure.

[All-Solid-State Lithium-Sulfur Battery]

A feature of an all-solid-state lithium-sulfur battery according to the present disclosure is to be provided with the above cathode. The all-solid-state lithium-sulfur battery is provided with a solid electrolyte layer and an anode, in addition to the cathode.

The solid electrolyte layer is a layer containing a solid electrolyte having lithium ion conductivity. The solid electrolyte is not particularly limited. Any known one as a solid electrolyte of an all-solid-state lithium-sulfur battery, such as a sulfide solid electrolyte and an oxide solid electrolyte, may be used. The structure of the solid electrolyte layer of the all-solid-state lithium-sulfur battery is obvious for the skilled person, and thus description thereof is omitted.

The anode is provided with a layer containing an anode active material, and optionally an anode current collector. Any known one as an anode of an all-solid-state lithium-sulfur battery may be used. The structure of the anode of the all-solid-state lithium-sulfur battery is obvious for the skilled person, and thus description thereof is omitted.

For example, one may stack the cathode, the solid electrolyte layer and the anode in this order and optionally pressing them, attach terminals etc. if necessary, and seal them in a battery case, to easily manufacture the all-solid-state lithium-sulfur battery according to the present disclosure.

### EXAMPLES

Hereinafter the present disclosure will be further described with Examples.

[Preparing Batteries for Evaluation]

Batteries for evaluation according to Examples 1 and 2 and Comparative Examples 1 to 10 were prepared as follows. Here, Table 1 shows the contents of a conductive aid, P₂S₅, and a solid electrolyte on the basis of the entire cathode mixture.

### Example 1

### (Preparing Cathode)

S and an SWCNT (TUBALL produced by OCSiAL, the fiber length and the diameter were as shown in Table 1) were weighed, so that the proportions by weight thereof were 72.0% and 28.0%, respectively, and were mixed in a mortar for 30 minutes. The obtained mixture was subjected to heat treatment in the atmosphere under the conditions at 150° C. for 1 hour, and the resultant S-CNT composite was obtained. Next, 1.620 g of the S-CNT composite and 0.385 g of P₂S₅ were weighed, and put into a jar of 45 cm³ for planetary ball milling made from zirconia (ZrO₂), 80 g of ZrO₂ balls of 4 mm in diameter was further put into the jar, and the jar was sealed. The sealed jar was attached to a planetary ball mill machine of P7 manufactured by Fritsch, and subjected to mechanical milling for 6 hours in total in which a cycle of: 1-hour mechanical milling at 400 rpm in rotation speed; a 15-minute rest; 1-hour mechanical milling reversely at 400 rpm in rotation speed; and a 15-minute rest was repeated. Whereby the resultant S-CNT-P₂S₅ composite was obtained. Next, 440 mg of butyl butyrate (produced by Kishida Chemical Co., Ltd.), 5 mg of a PVdF (polyvinylidene fluoride)-based binder (produced by KUREHA CORPORATION), 500 mg of the S-CNT-P₂S₅ composite, and 293 mg of a solid electrolyte (Li₂S—P₂S₅ based glass ceramic) were put into a vessel made from polypropylene (PP), and were stirred with an ultrasonic dispersive device (UH-50 manufactured by SMT Corporation) for 30 seconds. Next, the PP vessel was shaken with a mixer (TTM-1 manufactured by Sibata Scientific Technology Ltd.) for 3 minutes, further the contents therein were stirred with the ultrasonic dispersive device for 30 seconds, and the resultant coating fluid was obtained. A substrate of aluminum (Al) foil (produced by UACJ Corporation) that was a cathode current collector was coated with the obtained coating fluid, using an applicator according to a blade method. The coated layer was air-dried, and thereafter dried on a hot plate at 100° C. for 30 minutes. Then, a cathode layer was formed on one surface of the substrate of Al foil.

(Preparing All-Solid-State Lithium-Sulfur Battery)

Into a ceramic mold of 11.28 mm in diameter (1 cm² in area), 100 mg of a solid electrolyte same as the above was put and pressed at 10 kN/cm², and the resultant solid electrolyte layer was obtained. A stamped portion of the cathode layer which had a diameter of 11.28 mm was put on one side of the obtained solid electrolyte layer and pressed at 60 kN/cm², and the resultant laminate was obtained. Lithium metal foil that was an anode layer was put on the other side of the solid electrolyte layer and pressed at 10 kN/cm², and the resultant electrode body was obtained. The obtained electrode body was restrained at 2N m in torque with three M6 bolts, and the resultant battery for evaluation (all-solid-state lithium-sulfur battery) according to Example 1 was obtained.

### Example 2

A battery for evaluation according to Example 2 was obtained in the same way as in Example 1 except that S and an SWCNT were weighed, so that the proportions by weight thereof were 78.4% and 21.6%, respectively.

### Comparative Example 1

A battery for evaluation according to Comparative Example 1 was obtained in the same way as in Example 1 except that the S-CNT-P₂S₅ composite was prepared as follows.

S and VGCF (vapor grown carbon fiber, VGCF-H produced by SHOWA DENKO K.K.) were weighed, so that the proportions by weight thereof were 64.8% and 35.2%, respectively and were mixed in a mortar for 30 minutes, and the resultant S-CNT composite was obtained. Next, 1.620 g of the S-CNT composite and 0.385 g of P₂S₅ were weighed, and put into a jar of 45 cm³ for planetary ball milling made from zirconia (ZrO₂), 96 g of ZrO₂ balls of 4 mm in diameter was further put into the jar, and the jar was sealed. The sealed jar was attached to a planetary ball mill machine of P7 manufactured by Fritsch, and subjected to mechanical milling for 38 hours in total in which a cycle of: 1-hour mechanical milling at 500 rpm in rotation speed; a 15-minute rest; 1-hour mechanical milling reversely at 500 rpm in rotation speed; and a 15-minute rest was repeated. Whereby the resultant S-CNT-P₂S₅ composite was obtained.

### Comparative Example 2

A battery for evaluation according to Comparative Example 2 was obtained in the same way as in Comparative Example 1 except that S and VGCF were weighed, so that the proportions by weight thereof were 72% and 28%, respectively.

### Comparative Example 3

A battery for evaluation according to Comparative Example 3 was obtained in the same way as in Example 1 except that the SWCNT was changed to an SWCNT having a fiber length of 1 μm (TUBALL produced by OCSiAL), and that S and the SWCNT were weighed, so that the proportions by weight thereof were 64.8% and 35.2%, respectively.

### Comparative Example 4

A battery for evaluation according to Comparative Example 4 was obtained in the same way as in Comparative Example 3 except that S and the SWCNT were weighed, so that the proportions by weight thereof were 72% and 28%, respectively.

### Comparative Example 5

A battery for evaluation according to Comparative Example 5 was obtained in the same way as in Comparative Example 1 except that the VGCF was changed to an SWCNT having a fiber length of 5 μm (TUBALL produced by OCSiAL).

### Comparative Example 6

A battery for evaluation according to Comparative Example 6 was obtained in the same way as in Example 1 except that S and the SWCNT were weighed, so that the proportions by weight thereof were 64.8% and 35.2%, respectively.

### Comparative Example 7

A battery for evaluation according to Comparative Example 7 was obtained in the same way as in Example 1 except that S and the SWCNT were weighed, so that the proportions by weight thereof were 81.8% and 18.2%, respectively.

### Comparative Example 8

A battery for evaluation according to Comparative Example 8 was obtained in the same way as in Example 1 except that S and the SWCNT were weighed, so that the proportions by weight thereof were 85.2% and 14.8%, respectively.

### Comparative Example 9

A battery for evaluation according to Comparative Example 9 was obtained in the same way as in Example 1 except that the cathode was prepared without any solid electrolyte.

### Comparative Example 10

A battery for evaluation according to Comparative Example 10 was obtained in the same way as in Example 1 except that the cathode was prepared without P₂S₅.

[Measuring Discharge Specific Capacity]

Each of the prepared batteries for evaluation was evaluated. A charge-discharge test was performed using a charge-discharge system (manufactured by Toyo System Co., Ltd.) under the constant current conditions of: 1.5-3.1 V in voltage range; and 0.46 mA in current value. The discharge capacity (mAh) obtained in the second cycle was divided by the weight (mg) of the entire cathode, and the calculation thereof was defined as a discharge specific capacity (mAh/g). The results are shown in Table 1.

TABLE 1

| | Conductive aid | | | | Way to | Content of | Content of solid | Discharge |
|---|---|---|---|---|---|---|---|---|
| | | Fiber | | Content in | prepare | P₂S₅ in | electrolyte in | specific |
| | | length | Diameter | cathode | S-CNT | cathode | cathode mixture | capacity |
| | Type | (μm) | (nm) | mixture (wt %) | composite | mixture (wt %) | (wt %) | (mAh/g) |
| Comparative | VGCF | 6 | 150 | 22.9 | ball milling | 15.5 | 18.7 | 626 |
| Example 1 | | | | | | | | |
| Comparative | VGCF | 6 | 150 | 18.8 | ball milling | 15.5 | 18.7 | 564 |
| Example 2 | | | | | | | | |
| Comparative | SWCNT | 1 | 2 | 22.9 | fusing | 15.5 | 18.7 | 602 |
| Example 3 | | | | | | | | |
| Comparative | SWCNT | 1 | 2 | 18.2 | fusing | 15.5 | 18.7 | 550 |
| Example 4 | | | | | | | | |
| Comparative | SWCNT | 5 | 2 | 22.9 | ball milling | 15.5 | 18.7 | 564 |
| Example 5 | | | | | | | | |
| Comparative | SWCNT | 5 | 2 | 22.9 | fusing | 15.5 | 18.7 | 510 |
| Example 6 | | | | | | | | |
| Comparative | SWCNT | 5 | 2 | 11.8 | fusing | 15.5 | 18.7 | 598 |
| Example 7 | | | | | | | | |
| Comparative | SWCNT | 5 | 2 | 9.6 | fusing | 15.5 | 18.7 | 587 |
| Example 8 | | | | | | | | |
| Comparative | SWCNT | 5 | 2 | 22.9 | fusing | 19.0 | 0.0 | 119 |
| Example 9 | | | | | | | | |
| Comparative | SWCNT | 5 | 2 | 21.5 | fusing | 0.0 | 22.2 | 101 |
| Example 10 | | | | | | | | |
| Example 1 | SWCNT | 5 | 2 | 18.2 | fusing | 15.5 | 18.7 | 630 |
| Example 2 | SWCNT | 5 | 2 | 14.0 | fusing | 15.5 | 18.7 | 664 |

As can be seen in Table 1, the discharge specific capacity in Example 1, where the SWCNT was used, was higher than that in Comparative Example 2, where the VGCF was used. The discharge specific capacity in Example 1 was also higher than that in Comparative Example 1, where the content of the VGCF was higher than that in Comparative Example 2. They are believed to be because the diameter of an SWCNT is small, and thus the SWCNT had wider dispersibility than the VGCF in the cathode mixture.

As can be seen in Table 1, the discharge specific capacity in Example 1 was higher than that in Comparative Example 4, where the SWCNT having a fiber length of 1 μm was used. The discharge specific capacity in Example 1 was also higher than that in Comparative Example 3, where the content of the SWCNT was higher than that in Comparative Example 4. They are believed to be because the SWCNT having a fiber length shorter than 2 μm did not make it possible to appropriately secure an electron conduction path in the cathode mixture.

As can be seen in Table 1, the discharge specific capacities in Examples 1 and 2 were each higher than that in each of Comparative Examples 6 to 8. From this, it can be said that 12 wt % to 20 wt % of the SWCNT is contained.

As can be seen in Table 1, the discharge specific capacities in Comparative Examples 9 and 10 were each much lower than that in each of the other Examples and Comparative Examples. This is believed to be because a long ion conduction path in the cathode mixture was not secured in Comparative Example 9, and because an ion conduction path in the vicinity of the cathode active material in the cathode mixture was not secured in Comparative Example 10.

What is claimed is:

1. A cathode for an all-solid-state lithium-sulfur battery, the cathode comprising:
a cathode mixture containing sulfur, a carbon nanotube, P₂S₅, and an Li₂S—P₂S₅ based solid electrolyte, wherein
the sulfur, the carbon nanotube, and the P₂S₅ form a composite, and
the cathode mixture contains higher than 0 wt % and lower than 20 wt % of the carbon nanotube.
